(19) United States
(12) Patent Application Publication
(10) Pub. No.: US 2016/0155091 A1
(43) Pub. Date: Jun. 2, 2016

(54) METHODS AND A COMPUTING DEVICE FOR MAINTAINING COMMENTS FOR A DOCUMENT

(71) Applicant: WORKIVA INC., Ames, IA (US)

(72) Inventors: Brent Arndorfer, Mesa, AZ (US); Trent Grover, Ames, IA (US); Shane Sizer, Bozeman, MT (US); Jeffrey Orshalick, Tempe, AZ (US); Jason Moore, Bozeman, MT (US)

(21) Appl. No.: 14/817,444

(22) Filed: Aug. 4, 2015

Related U.S. Application Data
(60) Provisional application No. 62/086,178, filed on Dec. 1, 2014.

(51) Int. Cl. G06Q 10/10

(52) U.S. Cl. CPC G06Q 10/101

(57) ABSTRACT

In various implementations, a first computing device (such as cloud-based server) transmits instructions to a second computing device (such as a notebook computer, tablet computer, or smartphone). The instructions are usable by the second computing device to render at least a first portion of the document on a display. The first computing device receives an asset identifier and a user comment from the second computing device. The asset identifier uniquely identifies a discrete subset of user content within the document (such as particular paragraph, a table, or a cell within a table). The first computing device stores the comment (e.g., in a cloud-based database) in a data entity that is separate from a data entity in which the user content identified by the asset identifier is stored and associates the comment with the asset using the asset identifier.

### CROSS-REFERENCE TO RELATED APPLICATIONS

The present application claims priority to U.S. Provisional Patent Application 62/086,178, filed Dec. 1, 2014, the contents of which are incorporated herein by reference.

### TECHNICAL FIELD

The present disclosure is related generally to electronic document collaboration platforms and, more particularly, to methods and a computing device for maintaining comments for a document.

### BACKGROUND

Popular productivity software programs, such as those included in the Microsoft® Office® package, give users the ability to make comments directly within electronic documents. The typical workflow associated with such commenting features is as follows: a user authors a document and emails it to several other users for their input. Each of the other users then inserts comments into the document (which show up in the margins in the form of text bubbles) and sends the commented version of the document back to the creator (possibly copying the other reviewers). Additionally, each reviewer might choose to make edits to the document or make comments within the actual text of the document (essentially creating a new version of the document). It is then up to the author to synthesize and harmonize all of the various comments and revisions.

One problem that arises with the current document commenting paradigm is that there are no enforced restrictions on the ability of commentators to make changes to the document. Another is that the comments themselves, even when not applied in-line with the text, tend to be embedded within the documents being commented on. Thus, when the person responsible for creating the final version of the document has to incorporate all of the disparate comments and edits, he or she may be forced to ignore or modify comments that are inconsistent with others.

### DRAWINGS

While the appended claims set forth the features of the present techniques with particularity, these techniques, together with their objects and advantages, may be best understood from the following detailed description taken in conjunction with the accompanying drawings of which:

FIG. 1 is an example of a networking environment in which various embodiments of the disclosure may be employed;

FIG. 2 is a block diagram of a computing device according to an embodiment;

FIG. 3A through FIG. 3I show a user interface according to an embodiment;

FIG. 4 shows various types of data entities that make up a document according to an embodiment;

FIG. 5 shows an example of how the various entities of a document are related to one another according to an embodiment;

FIG. 6 shows an example of a mark-up language block of a section map entity according to an embodiment;

FIG. 7 shows an example of a mark-up language block of a tree entity according to an embodiment;

FIG. 8 shows an example of a mark-up language block of a section entity according to an embodiment;

FIG. 9A and FIG. 9B show different possible software architectures for a computing device from FIG. 1 according to an embodiment;

FIG. 10 shows additional entities created by a productivity server in an embodiment; and

FIG. 11 shows a procedure carried out in an embodiment.

### DESCRIPTION

This disclosure is generally directed to methods and a computing device for maintaining comments for a document. In an embodiment, a first computing device (such as a cloud-based server) transmits instructions to a second computing device (such as a notebook computer, tablet computer, or smartphone). The instructions (e.g., a block of mark-up language text or a set of drawing instructions delivered via JavaScript®) are usable by the second computing device to render at least a portion of the document on a display. The first computing device receives an asset identifier and a user comment from the second computing device. The asset identifier uniquely identifies a discrete subset of user content within the document (referred to herein as an “asset,” examples of which include a paragraph, a table, or a cell within a table). The first computing device stores the comment (e.g., in a cloud-based database) in a data entity that is separate from the data entity in which the user content identified by the asset identifier is stored. The first computing device associates the comment with the asset using the asset identifier (e.g., by instantiating a comment entity or comment thread entity that maps the asset identifier to the unique identifier of an entity containing the content). In some embodiments, the first computing device receives, from the second computing device, additional positioning data beyond the asset identifier (e.g., character offsets or character lengths, to assist in identifying the subset of user content to which the comment applies).

This disclosure will often refer to a “data entity” or specific types of data entities such as a “tree entity” or “section map entity.” The term “entity” as used herein refers to a separately accessible collection of data that resides in a database, such as an “object” within an object-oriented database or an “entity” on the Google App EngineTM platform. Also, this disclosure will often use the term “key name.” As used herein, a key name is an identifier, such as a globally unique identifier (“GUID”), which uniquely identifies an entity. In the examples described herein, a key name is usable to retrieve data entities from a database. In practice, a key name may be a long hexadecimal value (e.g., 32 digits). For the sake of simplicity, the key names shown in the examples are four digits. This disclosure also refers to different types of “identifiers” or “ids” (such as a “section id,” “table id” or “paragraph id”). As used herein, an id may be a GUID and have a structure similar to that of a key name. “User content” as used herein refers to the parts of a document that are viewed by users, such as text, tables, spreadsheets, images, and drawings (as opposed to metadata that is usable by a computing device but not generally viewed by a user). Finally, “document” as used herein includes any type of electronically stored document, including text documents, spreadsheets, presentations, drawings, diagrams, and composite documents that include elements of different types of documents.

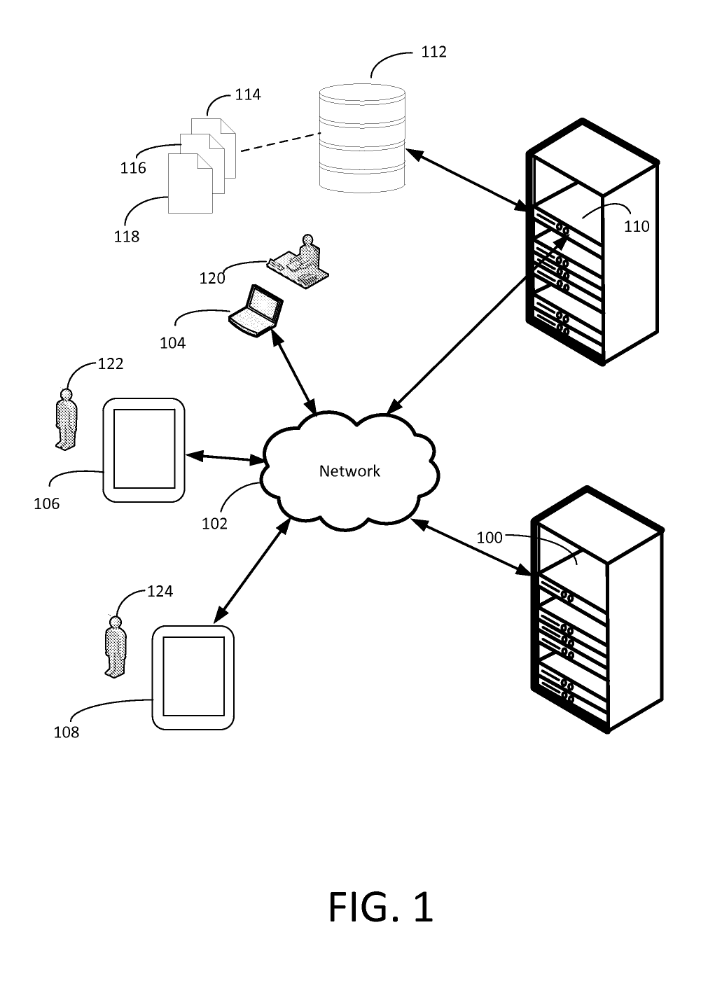

Various embodiments of the disclosure are implemented in a computer networking environment. Turning to FIG. 1, an example of such an environment is shown. A first computing device 100 is communicatively linked to a network 102. Possible implementations of the network 102 include a local-area network, a wide-area network, a private network, a public network (e.g., the Internet), or any combination of these. The network 102 may include both wired and wireless components. Also communicatively linked to the network 102 are a second computing device 104, a third computing device 106, a fourth computing device 108, and a fifth computing device 110. The fifth computing device 110 is communicatively linked to a media storage device 112 (e.g., a redundant array of independent disks). For the sake of example, it is assumed that a first user 120 operates the second computing device 104, a second user 122 operates the third computing device 106, and a third user 124 operates the fourth computing device 108.

Residing within the media storage device 112 are multiple documents, three of which are depicted in FIG. 1: a first document 114, a second document 116, and a third document 118. The first computing device 100 and the fifth computing device 110 are depicted as rack-mounted servers, the second computing device 104 is depicted as a notebook computer, and the third and fourth computing devices 106 and 108 are depicted as tablet computers. However, the computing devices depicted in FIG. 1 are merely representative. Other possible implementations of a computing device include a desktop computer and a smartphone. Furthermore, although the first, second, and third documents 114, 116, and 118 are depicted as being stored in a single device, they may, in fact, be stored on multiple storage devices (e.g., sharded into multiple physical chunks) of a cloud storage service. Finally, there may be more than or fewer than the first, second, and third documents 114, 116, and 118 residing on the media storage device 112.

For convenient reference, the first computing device 100 will also be referred to as a “productivity server 100” and the fifth computing device 110 will be also be referred to as a “database server 110.” Although depicted in FIG. 1 as separate devices, in some embodiments, the functionality of the productivity server 100 and the database server 110 are on the same device. The productivity server 100 executes one or more productivity programs. Under the control of the one or more productivity programs, the productivity server 100 interacts with the database server 110 and the computing devices 104, 106, and 108 to allow the computing devices to access the first document 114, the second document 116, and the third document 118 so that the first user 120, the second user 122, and the third user 124 can collaborate in commenting on the documents.

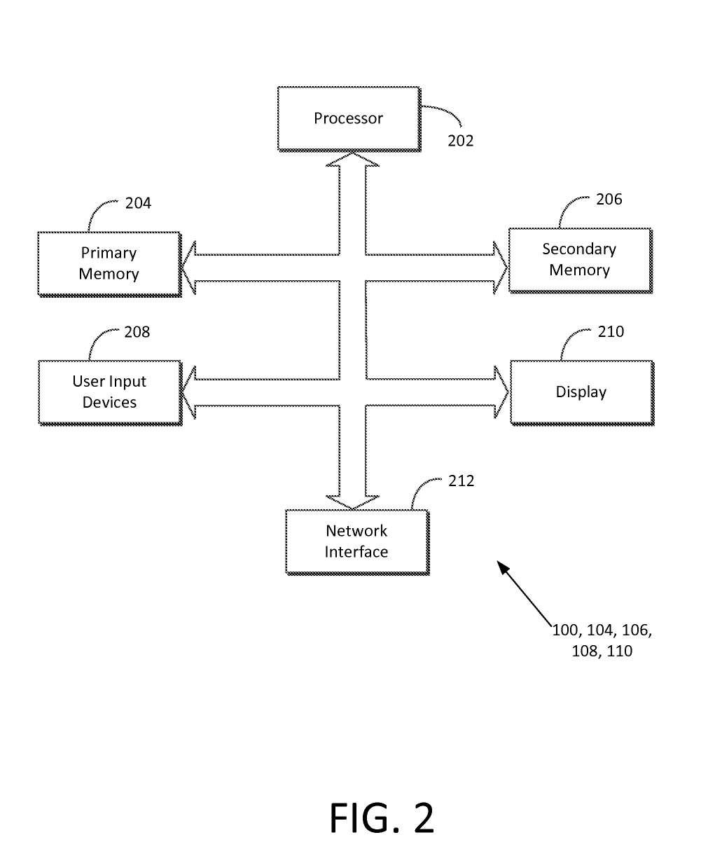

In one implementation, one or more of the computing devices of FIG. 1 have the general architecture shown in FIG. 2. The device depicted in FIG. 2 includes a processor 202 (e.g., a microprocessor, controller, or application-specific integrated circuit), a primary memory 204 (e.g., volatile memory, random-access memory), a secondary memory 206 (e.g., non-volatile memory), user input devices 208 (e.g., a keyboard, mouse, or touchscreen), a display 210 (e.g., an organic, light-emitting diode display), and a network interface 212 (which may be wired or wireless). The memories 204 and 206 store instructions and data. The processor 202 executes the instructions and uses the data to carry out various procedures including, in some embodiments, the methods described herein.

The computing devices of FIG. 1 (i.e., the processor 202 of each of the computing devices) are able to communicate with other devices of FIG. 1 via the network interface 212 over the network 102. In an embodiment, this communication takes place via a user interface that the productivity server 100 provides to the computing devices 104, 106, and 108. The specific nature of the user interface and what the user interface shows at any given time may vary depending what the user has chosen to view. Also, multiple users may interact with different instances of the user interface on different devices. In some embodiments, the productivity server 100 carries out calculations to determine how content is to be rendered on a computing device, generates rendering instructions based on those calculations, and transmits those rendering instructions to the computing device. Using the received instructions, the computing device renders the content on a display. In other embodiments, the productivity server 100 transmits instructions regarding an asset to a computing device. In carrying out the received instructions, the computing device performs the appropriate calculations locally to render the content of the asset on a display.

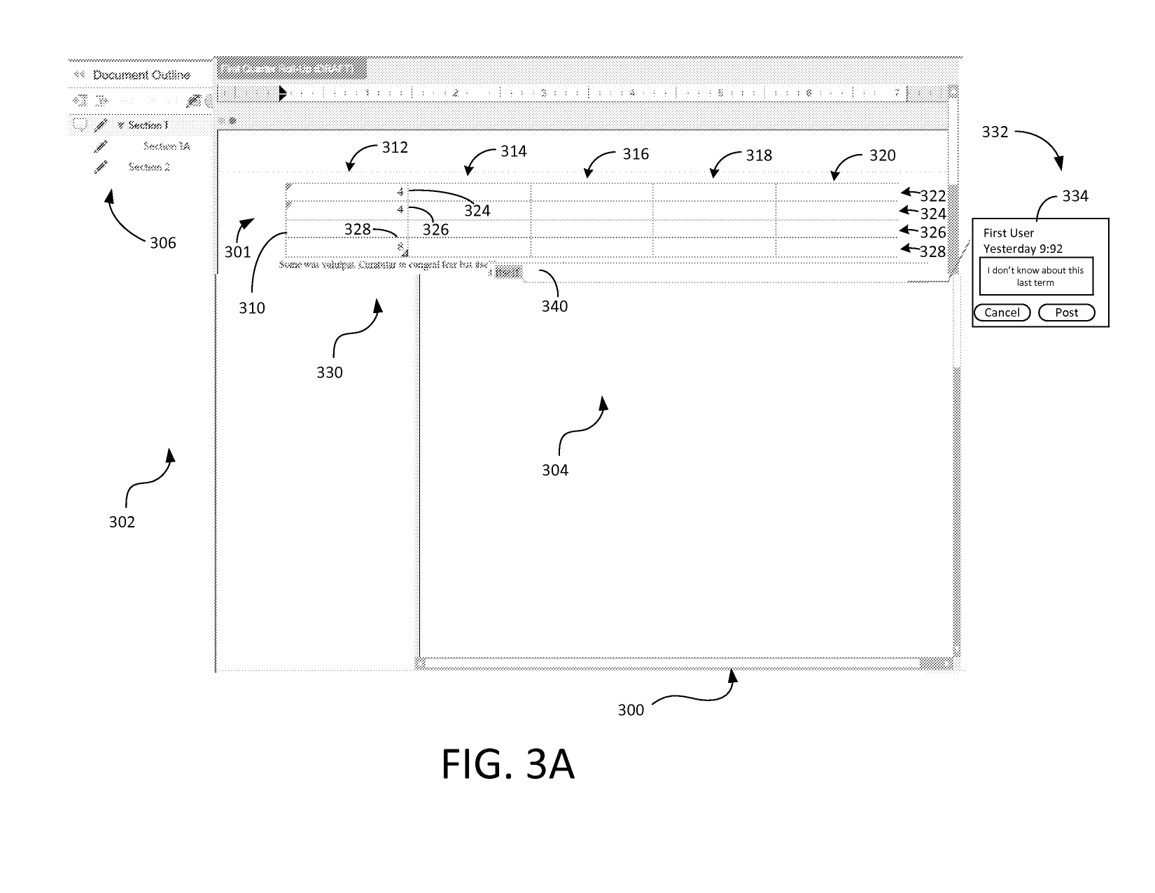

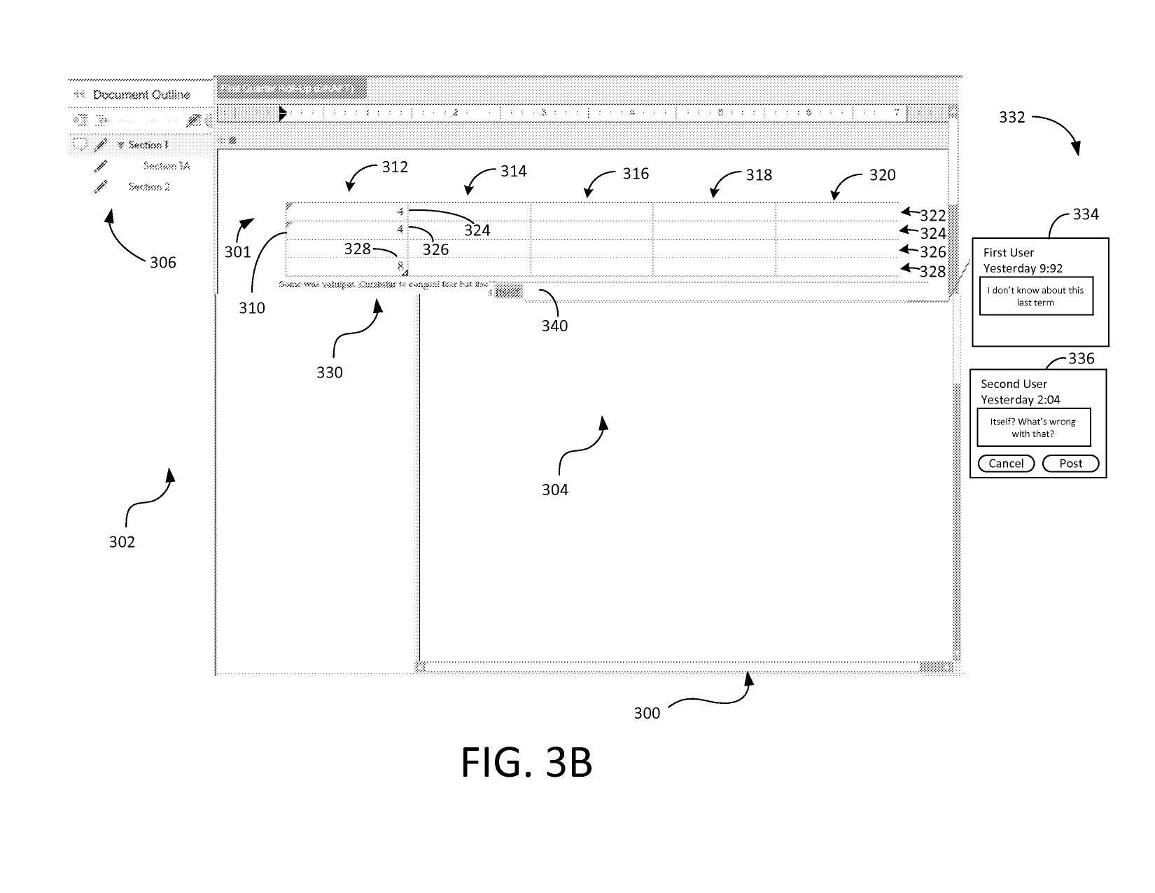

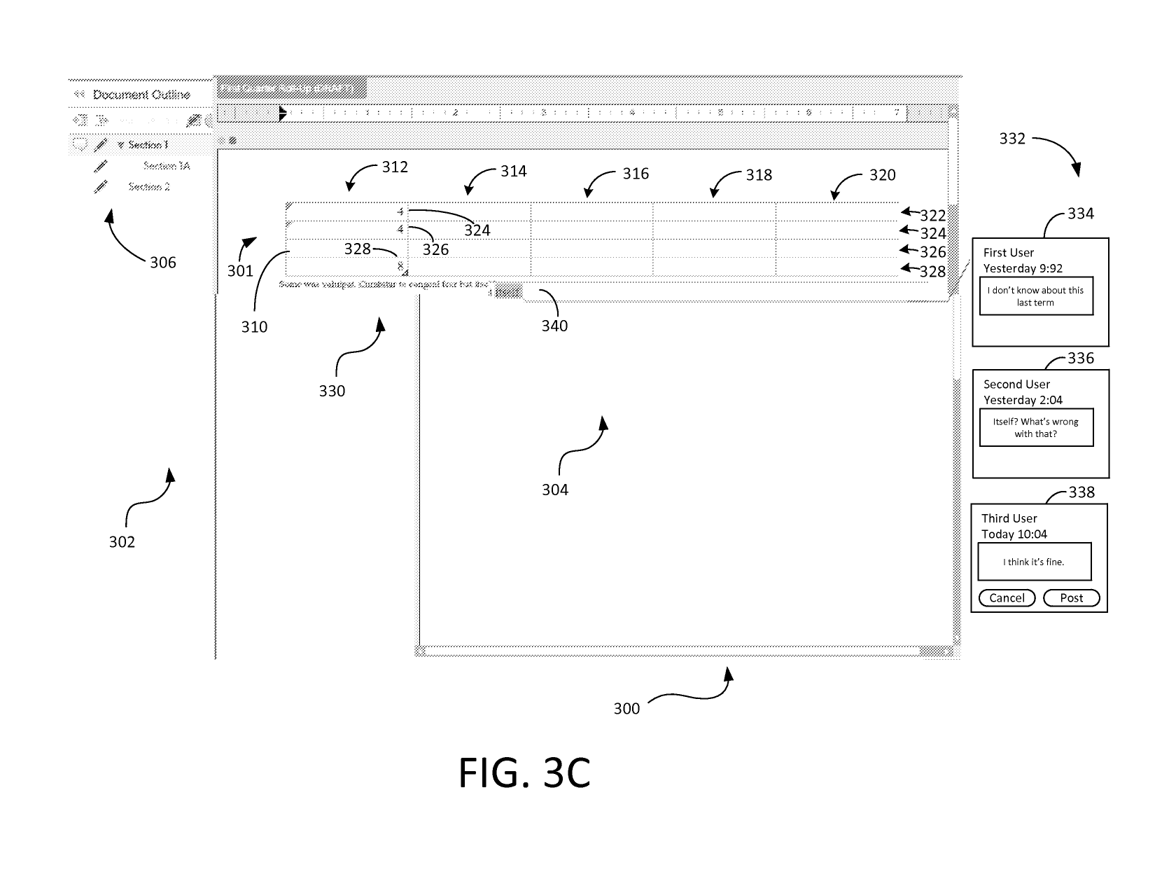

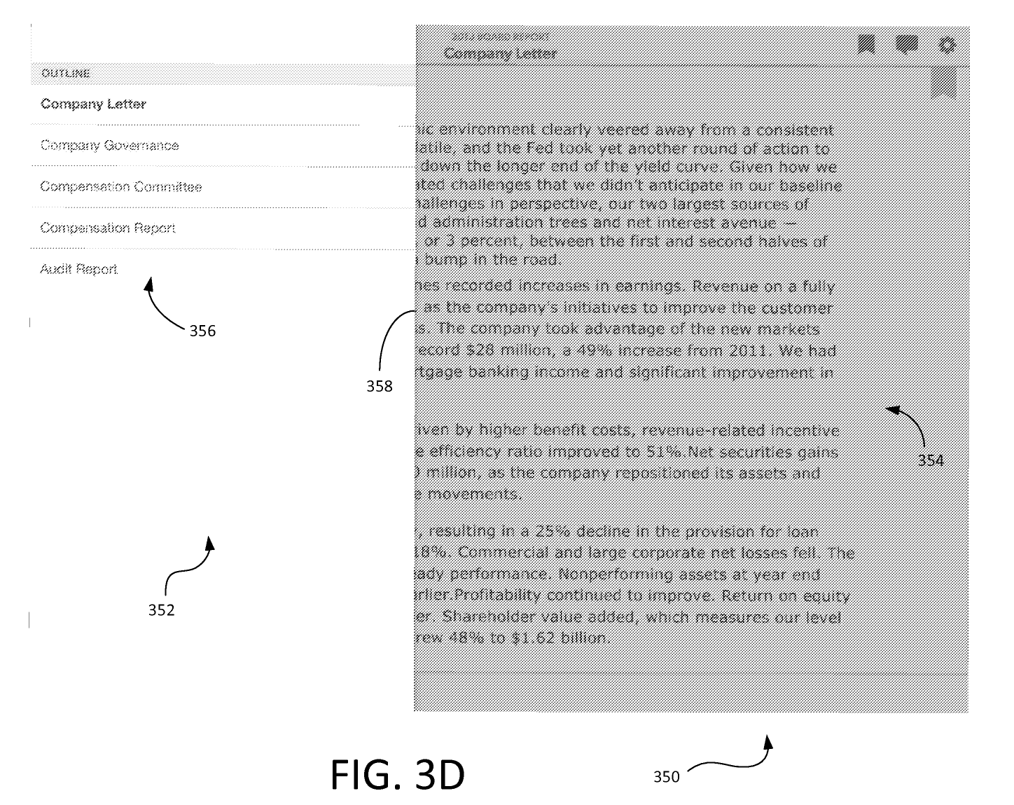

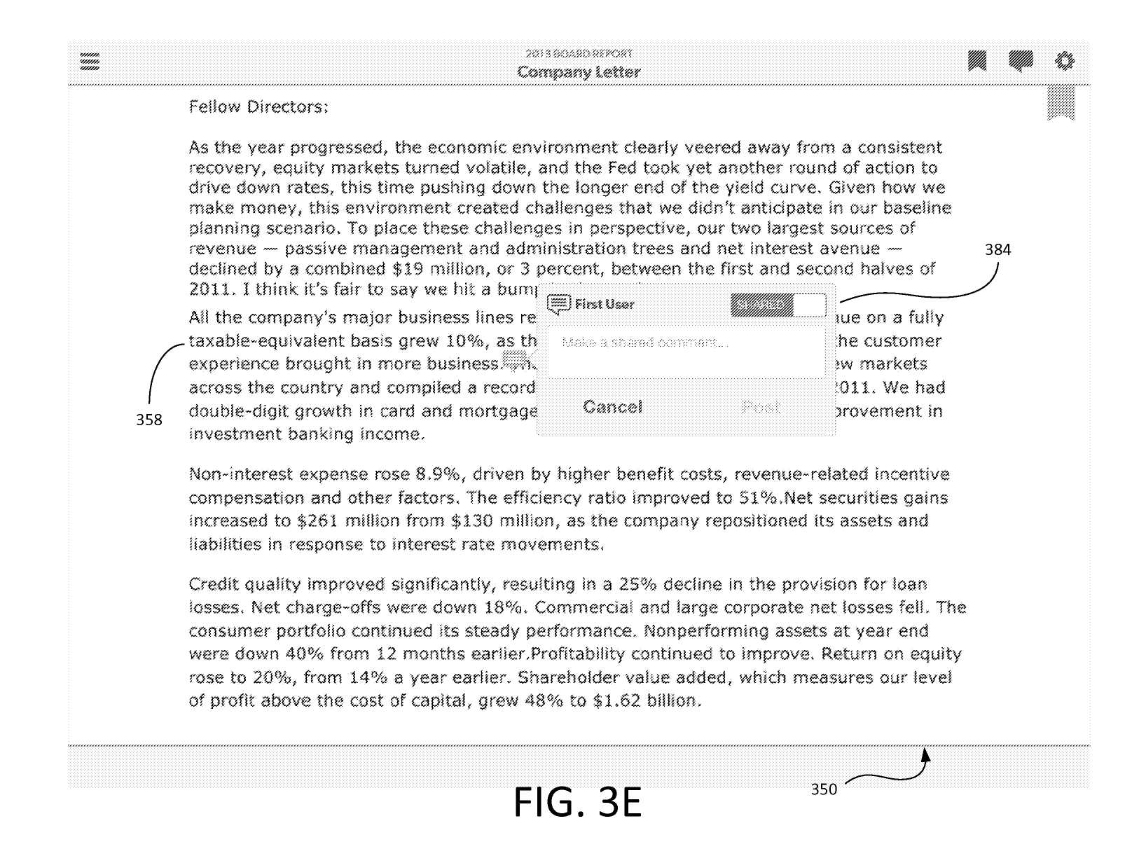

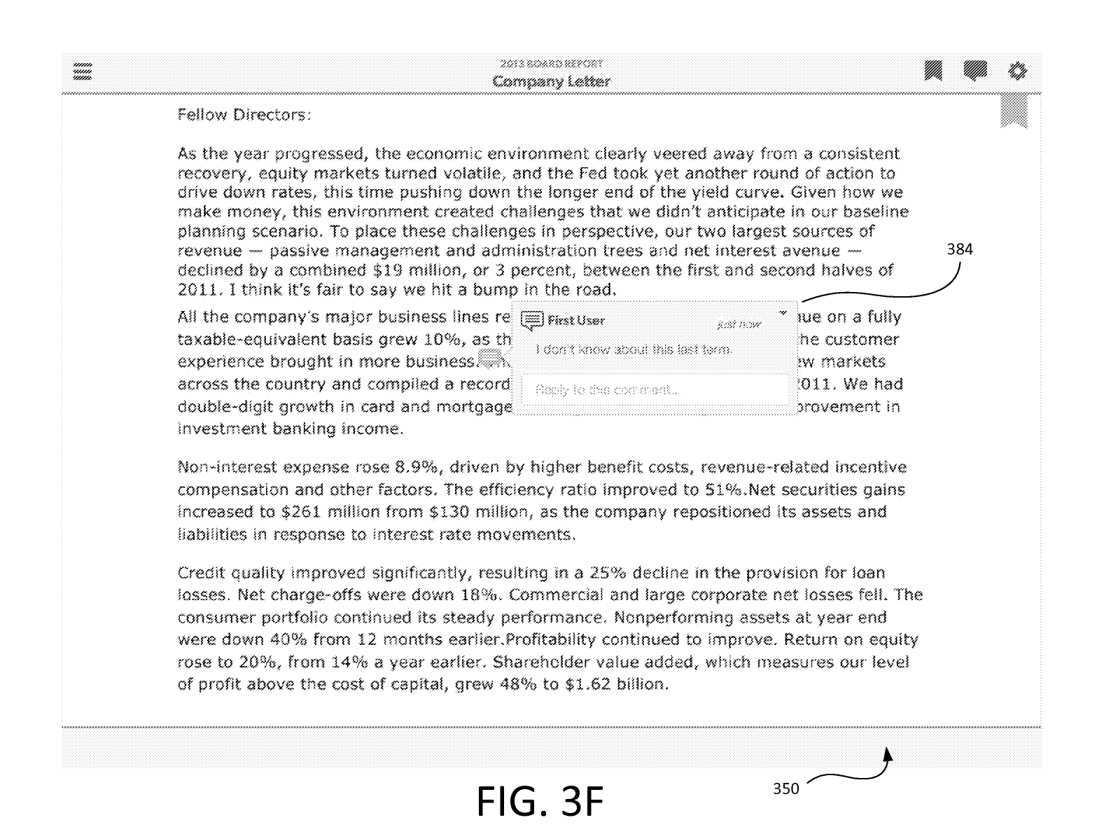

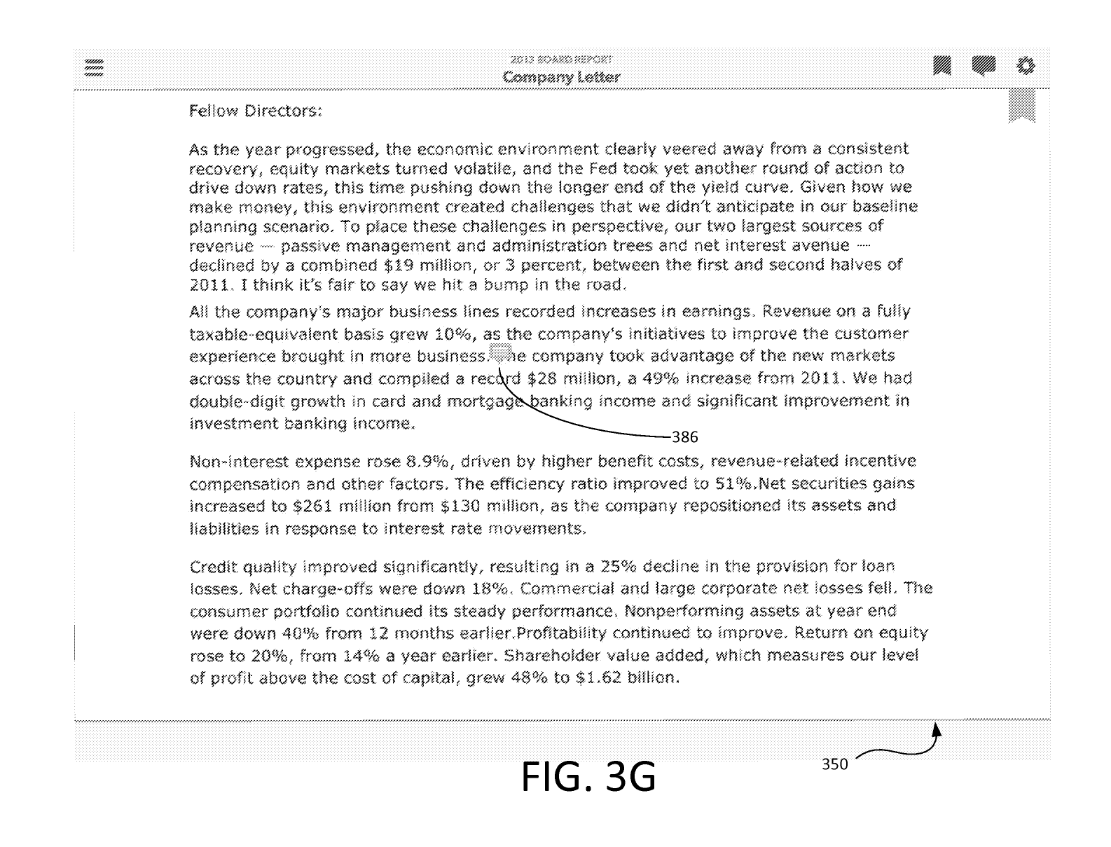

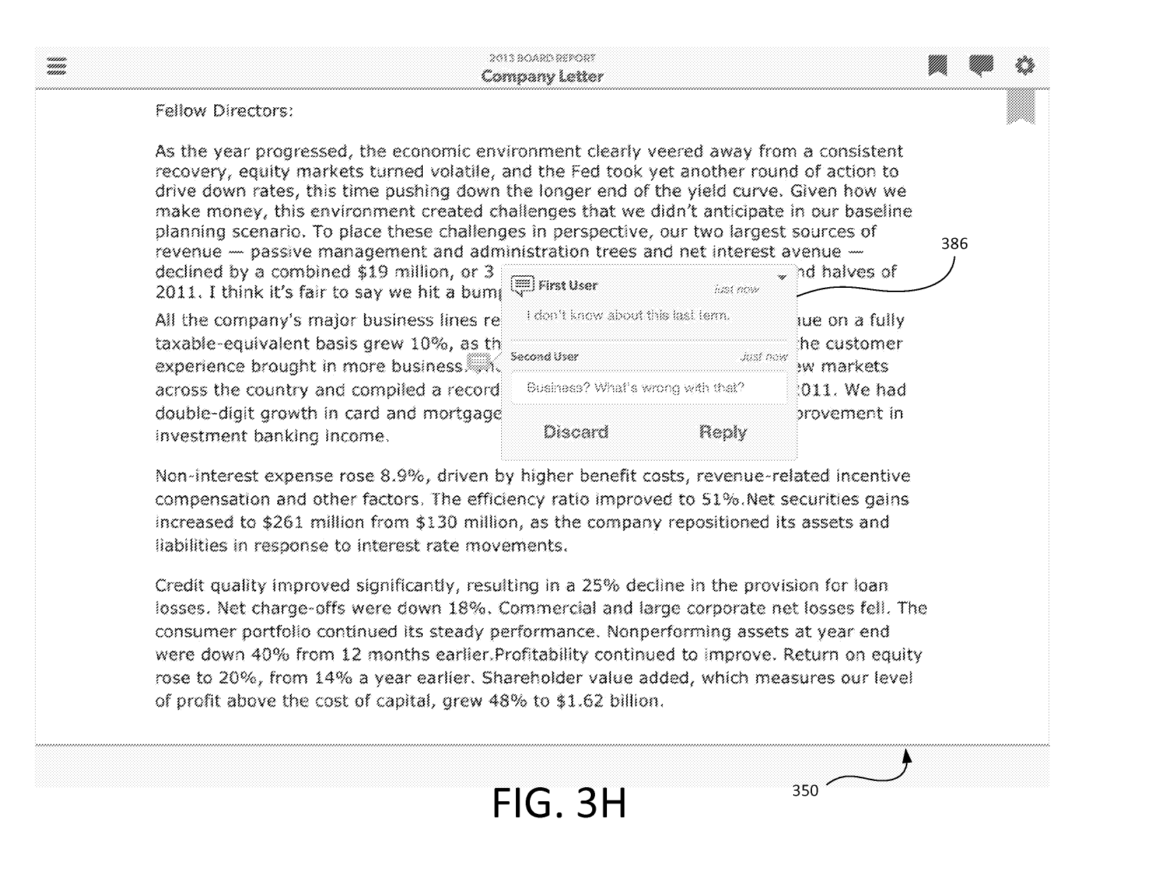

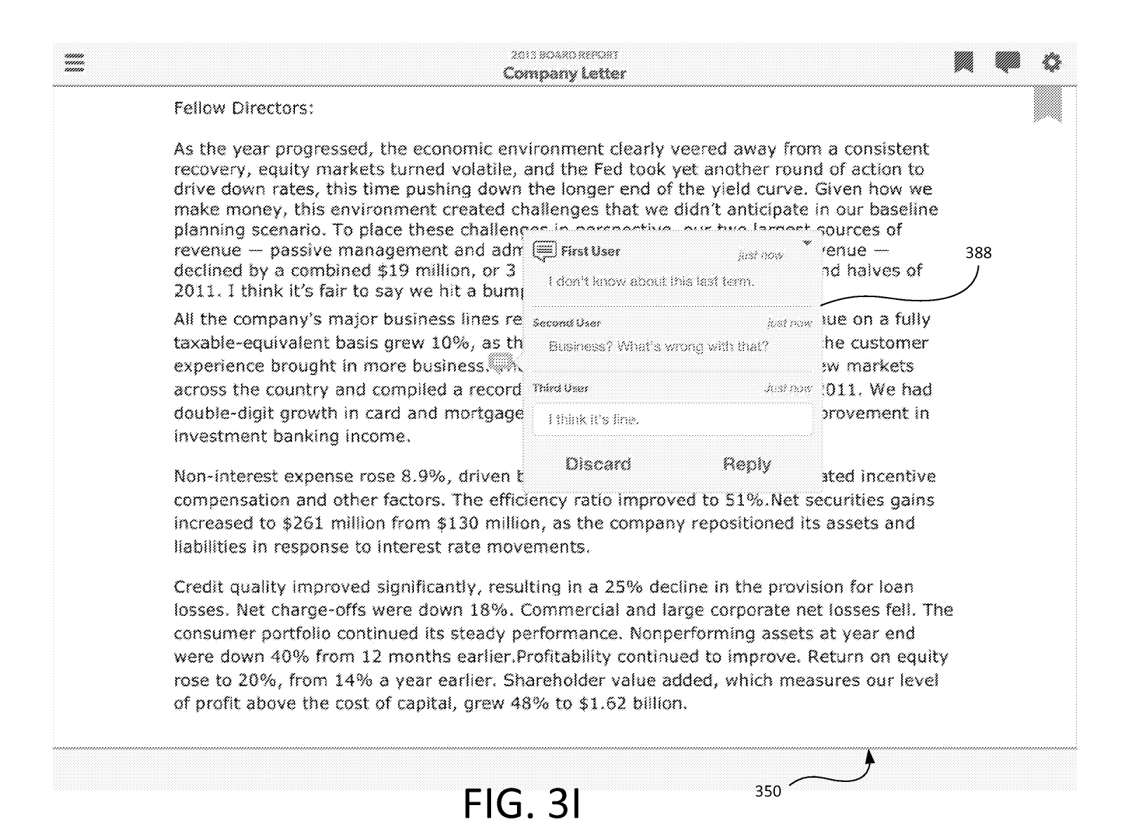

Turning to FIG. 3A, an example of a user interface that allows a user to anchor comments to selected portions of text is shown. The user interface 300 includes an outline area 302 and a user content area 304. In the outline area 302 is an outline 306, which shows the section structure of the document.

As noted above, various embodiments of the disclosure include a commenting feature that allows a computing device to detect the location on the display where a comment is to be entered (i.e., the location that is to serve as the “anchor” for the comment), map the location (e.g., the XY display coordinates) to the underlying asset (e.g., the paragraph and character offset), and have that comment be stored (e.g., by the productivity server 100) separately from the content itself. The way in which a computing device carries out this commenting feature depends on the architecture being employed by the computing device.

In some embodiments, the user's computing device presents (on the user interface) a non-editable version of a document (e.g., a document on which the user has no editing rights), and the user is limited to reviewing the document. In other embodiments, the user's computing device presents an interface that allows the user to make changes to the document in addition to commenting. Furthermore, in some embodiments, the computing device allows a user to “anchor” a comment on the basis of an XY position (which the computing device maps to the underlying content). Possible ways in which the computing device may keep track of the location of such an anchor include (1) an absolute coordinate (e.g., an absolute screen coordinate), (2) a distance offset from a reference point, and (3) a relative offset from a reference point. An example of a reference point is an upper left corner of a visual representation of an asset (e.g., a paragraph or individual character of text). An example of a relative offset from a reference point is a percentage offset from an upper left corner of an asset, with 100% being the distance from the upper left corner of the asset to the lower right corner of the asset. Examples of units of distance for an offset include characters and points.

For example, the user executes a long tap/click (or right-click) somewhere in the document area, which triggers the computing device to create (or request the productivity server to create) an XY comment (a popover dialog is displayed for the user to type in a comment). The user's computing device (and all other users' computing devices that open the document) displays an icon indicating the existence of an XY comment displayed at that document location thenceforth. Again, no highlighted text selection is displayed to the user by the computing device, though the comment is invisibly “anchored” to a specific piece of content by the productivity server 100.

In some embodiments, the user's computing device allows the user to select the “anchor” by selecting content (e.g., a section of text, an image, or a table cell). The content is selected and/or highlighted, and a comment is “anchored” to that selection.

In some embodiments, the computing device anchors XY comments to a single content location in the document (e.g., one character of text or a table cell). Selection-based comments may have two “anchor” points, representing the starting and ending points of the associated content selection. These two content “anchor” points are independent, so, for example, it is possible for a “selection” to start in a paragraph of text and end in a table cell.

In an embodiment, the computing device (the user's or the productivity server) determines the content to which the XY comment applies based on a combination of hierarchical identifiers, such as document id, section id, paragraph id, and character offset. The computing device can use this data to traverse through the hierarchy of data to the most specific piece of content (e.g., character in a paragraph, table cell, or image).

In the example of FIG. 3A, the document currently being displayed has three sections, which are listed in the section outline 306 by their friendly names: Section 1, Section 1A (which is a sub-section of Section 1), and Section 2. When a computing device displaying the user interface 300 detects a user input on the section outline 306 (e.g., detects a mouse click on a friendly name of a section) the computing device interprets the user input as a request for a section and reacts by requesting the section from the productivity server 100 (or, if the computing device has previously received the section from the productivity server 100, by switching to the section) and rendering the section on the display 210.

In the example of FIG. 3A, the user content includes a first paragraph 301 having a table 310. The table 310 includes a first column 312, a second column 314, a third column 316, a fourth column 318, and a fifth column 320. The table also has a first row 322, a second row 324, a third row 326, and a fourth row 328. The user content also includes a second paragraph 330 of text. The mechanics of how the user interface 300 may be delivered to the computing devices 104, 106, and 108 by the productivity server 100 and rendered by the computing devices is discussed in more detail below.

According to an embodiment, each instance of the user interface 300 provides the users of FIG. 1 (on their respective computing devices) with the ability to input comments (e.g., reviewer comments regarding the content shown in the user content area 304) and share those comments with the other users. In order to do so, a user need only place the cursor in some location on the user interface 300 and interact with an on-screen control (e.g., a right-click pop-up menu or menu from an on-screen control or toolbar, or a hand drawn comment entered with a stylus). If desired, the user may also select user content (e.g., to indicate content to which the comment pertains). In FIG. 3A, FIG. 3B, and FIG. 3C, the portion of the document being shown on the user interface 300 has anchored thereto a comment thread 332, which includes a first comment box 334, a second comment box 336 (on FIGS. 3B and 3C), and third comment box 338 (on FIG. 3C).

To illustrate the commenting functionality of the user interface 300, assume that the first user 120 views the user interface 300 on the second computing device 104 and wishes to make a comment. The first user 120 interacts with the user interface 300 via one of the user input devices 208, selects a portion 340 of the user content (in this case, the word “itself”), and right-clicks to display a pop-up menu (not shown). The first user 120 then selects “Add Comment.” The user interface 300 displays the first comment box 334, allowing the first user 120 to add the comment. The first user 120 then clicks the “Post” button on the first comment box 334 (FIG. 3A). Later, the second user 122 views that same part of the document (i.e., the part having the commented portion 340) on the user interface 300 on the third computing device 106 and wishes to make a comment in response to the first user's comment (i.e., to add to the comment thread 332). The second user 122 interacts with the user interface 300 (in a manner similar to how the first user 120 interacted with the user interface 300) and enters a comment into the second comment box 336 (FIG. 3B). Finally, the third user 124 views the portion of the document that includes the commented portion 340 and selects the option to add a comment to the comment thread 332. The third user 124 interacts with the user interface 300 in a manner similar to how the first user 120 and the second user 122 did when entering comments. The third user 124 enters a comment into the third comment box 338 (FIG. 3C). The various actions taken by the productivity server 100 to associate the comment thread 332 and the various comments in the thread with the selected content 340 will be described in further detail below.

Turning to FIG. 3D, an example of another embodiment of a user interface is shown, which may be employed on a touchscreen interface (e.g., on a tablet computer). In this embodiment, the user is not able to select portions of text directly, but is able to select an XY location on the document. The user interface 350 includes an outline area 352 and a user content area 354. In the outline area 352 is an outline 356, which shows the section structure of the document. In the example of FIG. 3D, the document currently being displayed has five sections, which are listed in the section outline 356 by their friendly names. The functionality of the user interface 350 of FIG. 3D (and FIG. 3E through FIG. 31) is otherwise similar to that of the user interface 300 of FIG. 3A through FIG. 3C except for the commenting functionality (discussed below).

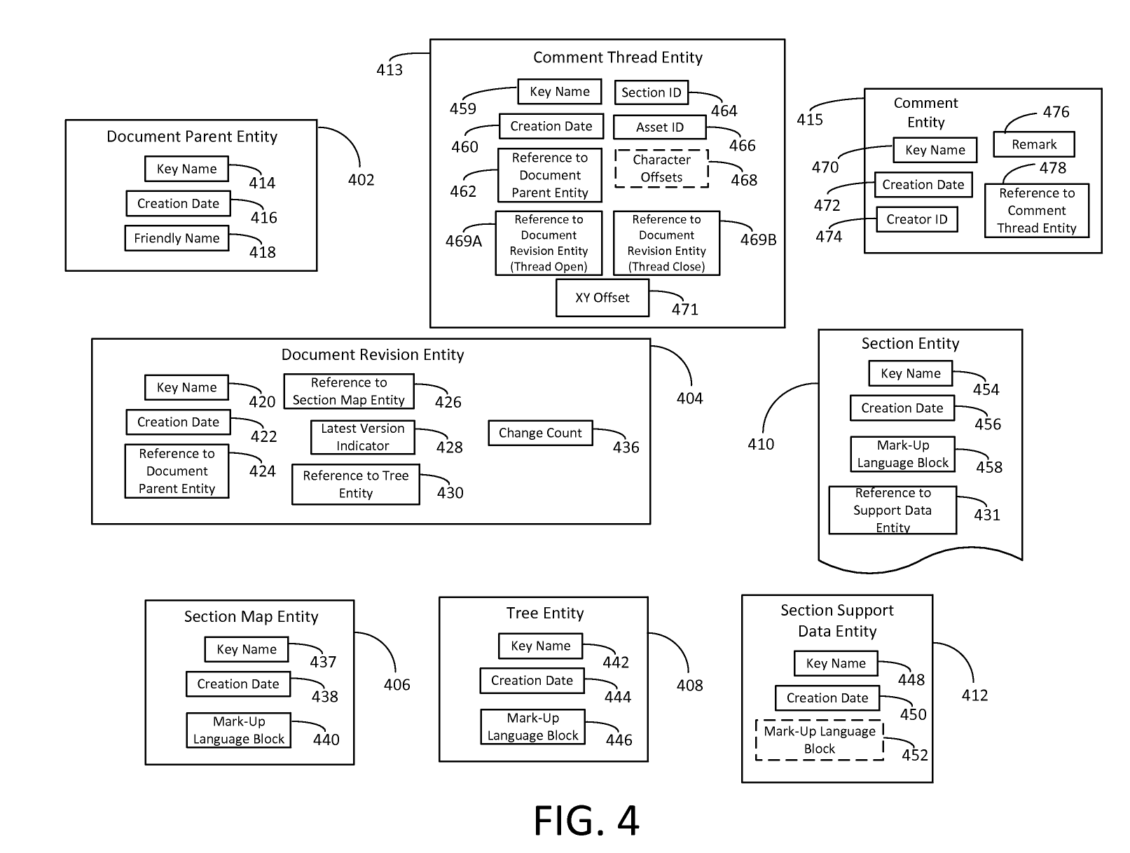

In an embodiment, the productivity server 100 organizes each document into multiple entities, each of which is separately stored in, and separately retrievable from the media storage device 112 by the database server 110 (e.g., at the request of the productivity server 100). In one embodiment, the entities that constitute a document have the organizational structure depicted in FIG. 4, in which the topmost entity is a document parent entity 402. There is a single document parent entity for any given document. The organizational structure for a document also includes a document revision entity 404. Although only one document revision entity is depicted in FIG. 4, there may be multiple document revision entities associated with each document. Associated with the document revision entity 404 are a section map entity 406, a tree entity 408, a section entity 410, and a section support data entity 412. Although only one section entity is depicted in FIG. 4, there may be multiple section entities associated with each document revision entity. Also, a document may include one or more comment thread entities, represented in FIG. 4 by the comment thread entity 413, as well as one or more comment entities per comment thread entity, represented by the comment entity 415.

Each of the entities depicted in FIG. 4 includes one or more pieces of data. For example, the document parent entity 402 includes a key name 414. The document parent entity 402 also includes a creation date 416. The creation date 416 is the date that the document parent entity 402 (as well as the document it represents) was created, which, in this example, is in YYYY-MM-DD HH:MM:SS format. Each of the other creation dates referred to herein have the same property, i.e., each creation date is the date that the entity in which it resides was created. The document parent entity 402 also includes a friendly name 418, which is the friendly name of the document (e.g., “First Quarter Roll-Up,” as shown in FIG. 3A, FIG. 3B, and FIG. 3C). The document revision entity 404 includes a key name 420, a creation date 422, a reference 424 to the document parent entity 402 (e.g., the value of the key name 414 of the document parent entity 402), a reference 426 to the section map entity 406 (e.g., the value of the key name 437 of the section map entity 406), a latest version indicator 428, which indicates whether the document revision entity 404 is associated with the most recent revision of the document, a reference 430 to the tree entity 408 (e.g., the value of the key name 442 of the tree entity 408), and a change count 436. The section map entity 406 includes a key name 437, a creation date 438, a mark-up language block 440, and a reference 431 to the section support data entity 412 (e.g., the key name 448 of the section support data entity 412). The tree entity 408 includes a key name 442, a creation date 444, and a mark-up language block 446. The section entity 410 includes a key name 454, a creation date 456, and a mark-up language block 458. The section support data entity 412 includes a key name 448, a creation date 450, and, in some embodiments, a mark-up language block 452 that identifies text within the document (text corresponding to the section entity 410) that has been selected as being the “anchor” for a comment.

Referring still to FIG. 4, the comment thread entity 413 includes a key name 459, a creation date 460, and a reference 462 to the document parent entity with which the comment thread is associated (e.g., the key name 414 of the document parent entity 402). The comment thread entity 413 also includes data that indicates the content in the document with which the comment thread is to be associated, including a section id 464 of the associated section and an asset id 466 (e.g., paragraph id, table id, graphic object id, chart id, or picture id) of the content within the section. In some embodiments, as discussed below, the comment thread entity 413 includes character offsets 468 (e.g., a starting offset and an ending offset) indicated the specific content (within the identified asset or assets) with which the comment is to be associated. The character offsets 468 may be present when the computing device provides the user with the ability to select specific blocks of text within a paragraph, for example. The comment thread entity 413 further includes a reference 469A to (e.g., the key name of) the document revision entity in which the comment thread was opened and a reference 469B to (e.g., the key name of) the document revision entity in which the comment thread was closed (e.g., the last document revision in which comments were posted or permitted in the thread). The comment thread entity 413 further includes an offset 471. Possible implementations of the offset include those set forth previously. In an embodiment, the offset 471 is an actual 2D position offset from the “anchor” content position that gives one or more of the computing devices fine-grained positional information for the comment thread. For example, the document id, section id, paragraph id, character offset may allow the one or more of the computing devices 104, 106, 108 and the productivity server 100 to “anchor” the comment to a character (e.g., top left corner of a character) an image, or a table cell. In some embodiments, the XY offset gives a 2D offset value that allows the devices to pinpoint an exact 2D screen position (e.g., pinpoint the exact position within an image or large table cell that was selected by the user). The computing devices and the productivity server may also use this information for “anchoring” comments made in document margins to nearby content. In an embodiment, a single comment may be associated with multiple assets within the document. For example, a comment could be be associated with a range that starts at a certain character position in a text paragraph and ends in a cell of a table.

The comment entity 415 includes a key name 470, a creation date 472, a creator id 474, a remark 476, and a reference 478 to the comment thread with which the comment entity 415 is associated (e.g., the key name 414 of the comment thread entity 413).

One or more of the computing devices of FIG. 1 may use the mark-up language block 446 of the tree entity 408 to render an outline in the outline area 302, and use the mark-up language block 458 of the section entity 410 to render user content in the user content area 304. In some embodiments, one or more of the second computing device 104, the third computing device 106, and the fourth computing device 108 processes and renders the mark-up language block locally. In some embodiments, the productivity server 100 processes the mark-up language block and “remotely” renders the user content on one or more of those computing devices. In particular, the productivity server 100 translates the mark-up language block into drawing commands and transmits those drawing commands to the computing device (which displays the user content in accordance with the drawing commands).

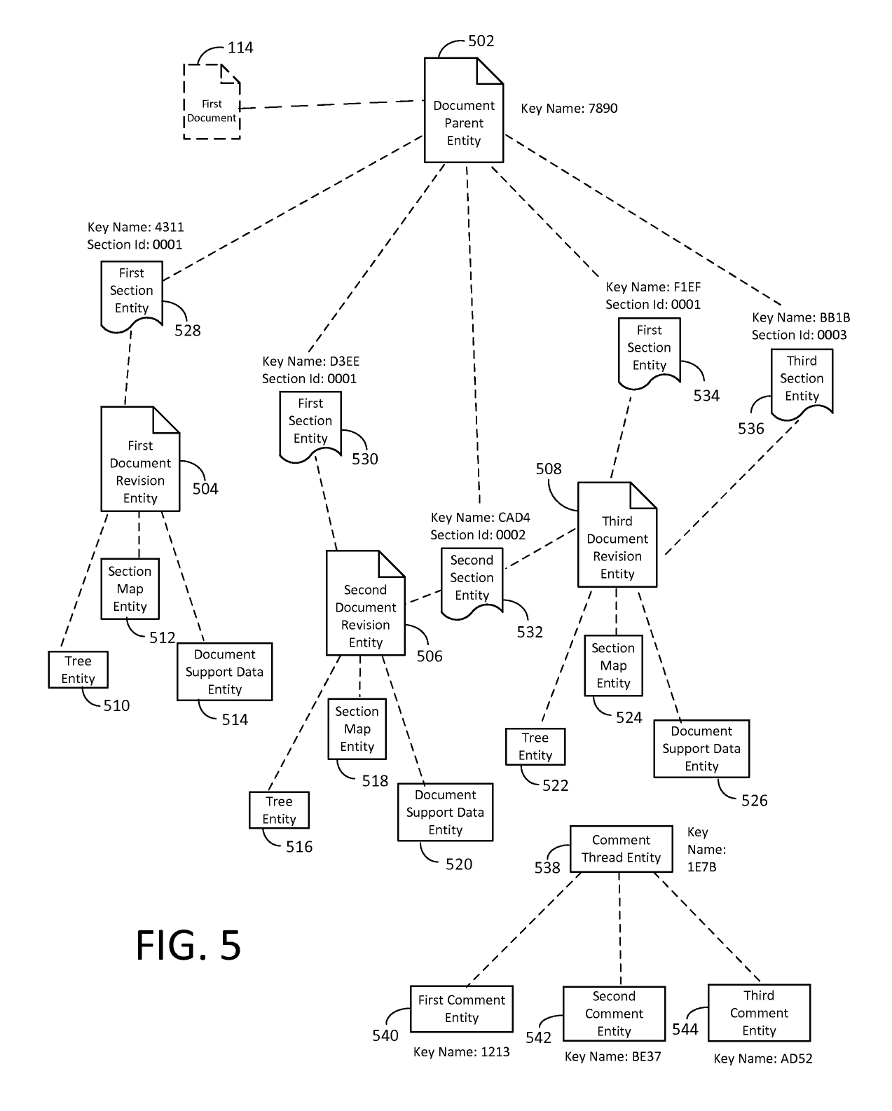

Turning to FIG. 5, a more specific example of how a document is organized according to an embodiment is shown. In this example, the entities that make up the first document 114 include a document parent entity 502, a first document revision entity 504, a second document revision entity 506, and a third document revision entity 508. The entities of the document also include, for each document revision entity, a tree entity, a section map entity, and a support data entity. For example, there is a tree entity 510, a section map entity 512, and a document support data entity 514 for the first document revision entity 504; a tree entity 516, a section map entity 518, and a document support data entity 520 for the second document revision entity 506; and a tree entity 522, a section map entity 524, and a document support data entity 526 for the third document revision entity 508.

Continuing with FIG. 5, in an embodiment, the user content of each document revision is stored within entities referred to as “sections.” Each document has at least one section entity per document revision entity. For example, the first document revision entity 504 is associated with a first section entity 528, the second document revision entity 506 is associated with a first section entity 530 (which is, in effect, a new and presumably revised instance of the first section entity 528) and a second section entity 532. The third document revision entity 508 is associated with a first section entity 534 (which is, in effect, a new and presumably revised instance of the first section entity 530), the second section entity 532 (the same instance that is associated with the second document revision entity 506), and a third section entity 536.

According to an embodiment, the productivity server 100 creates a new section entity whenever (1) it creates a document (the first revision of a document is associated with such a new section entity), (2) a user prompts the creation of a new section (e.g., via a user interface described in more detail below), or (3) a user shares a revision to an existing section. Each new version of a section entity keeps the same section id as the section entity from the previous version. However, each new version of a section entity has its own distinct key name, since it is retrievable as a unique entity by the database server 110. For example, each revision of the first section entity in FIG. 4 (first section entities 528, 530, and 534) has a section id of 0001. However, each revision has a different key name.

For example, the progression of entity creation in FIG. 5 might occur as follows: the first user 120 prompts the productivity server 100 to create the first document 114. In response, the productivity server 100 creates the document parent entity 502 and the first document revision entity 504. The first user 120 edits (e.g., inserts some text in) the first section of the document 114. Once the first user 120 is ready to share the edits with the other two users, the first user 120 interacts with the user interface 300 on the second computing device 104 to prompt the productivity server 100 to create the first section entity 528, associate the first section entity 528 with the first document revision entity 504, store the edits within the first section entity 528 (e.g., in the mark-up language block of the first section entity 528), and provides access to the section entity 528 to the other users. The first user 120 then resumes editing the first document 114 by (again, through input into the user interface 300) making additional edits to the first section of the document 114. The first user 120 also prompts the productivity server 100 to create a new section (via the user interface 300) and begins editing the new section. At some point, the first user 120 “shares” the new section (via the user interface 300). In response, the productivity server 100 creates the second document revision entity 506, creates another “first” section entity 530 (in which it stores the user content of the revised first section), creates the second section entity 532 (in which it stores the user content of the newly-created second section) and associates the second section entity 532 with the second document revision entity 506.

Continuing with the example, assume that the first user 120 once again resumes editing the first document 114. The first user 120 makes further edits to the first section of the first document 114, but does not make any to the second section. The first user 120 prompts the productivity server 100 to create a third section (via the user interface 300), makes edits to the third section, and then shares the new set of edits with the other users. In response, the productivity server 100 creates the third instance of the first section entity 534 (in which it stores the user content of the most recently revised first section), associates the second section entity 532 with the third document revision entity 508 (a new “second” section entity is not required since no changes were made to the second section), and creates the third section entity 536 (in which it stores the user content of the newly-created third section).

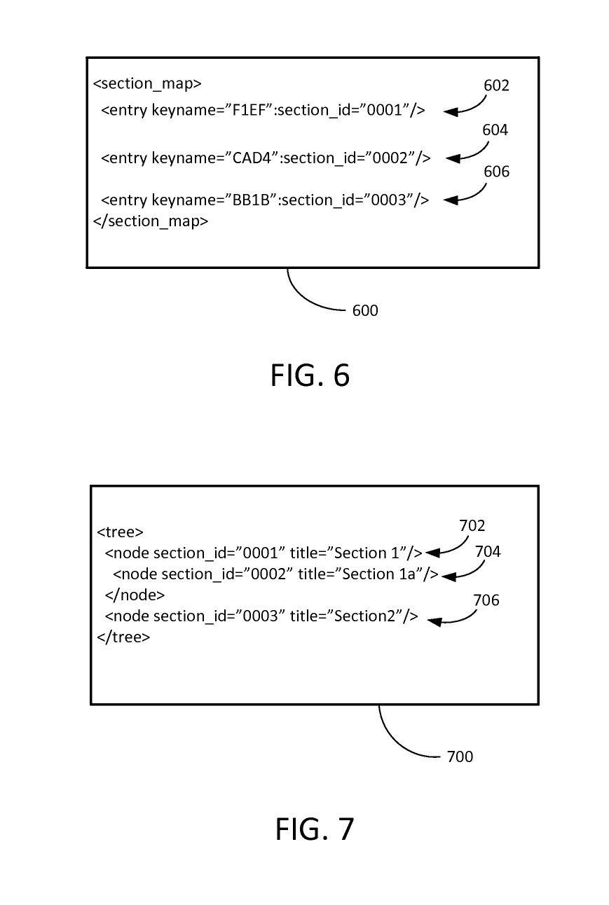

In an embodiment, the productivity server 100 keeps track of which section entities are to be used with a document revision via the mark-up language block of the section map associated with that document revision. The mark-up language block of the section map serves to map the section ids (which remain the same from document revision to document revision) to the section key names (which change with each new version of a section). FIG. 6 depicts an example of a mark-up language block that may be associated with the section map 524 of the third document revision entity 508. The mark-up language block 600 includes a first element 602, a second element 604, and a third element 606. The first element 602 includes the key name of the version of first section entity associated with the third document revision entity 508 (i.e., the first section entity 534—F1EF in this example) and the section id of the first section (0001 in this example). The second element 604 includes the key name of the second section entity 532 (CAD4 in this example) and the section id of the second section (0002 in this example). The third element 606 includes the key name of the third section entity 536 (BB1B in this example) and the section id of the third section entity 536 (0003 in this example).

In an embodiment, in order to structure the layout of the outline 306 and to react properly to user input with respect to the outline 306, a computing device uses a mark-up language block of the relevant tree entity (e.g., the mark-up language block 446 of the tree entity 408). FIG. 7 depicts an example of a mark-up language block that may be associated with the section map 524 of the third document revision entity 508. The mark-up language block 700 includes an element for each section of the first document 114. Each element includes the section id and friendly name of the section to which it corresponds. For example, a first element 702 includes the section id (0001) and friendly name (“Section 1”) for the first section, a second element 704 includes the section id (0002) and friendly name (“Section 1a”) for the second section, and a third element 706 includes the section id (0003) and friendly name (“Section 2”) for the third section.

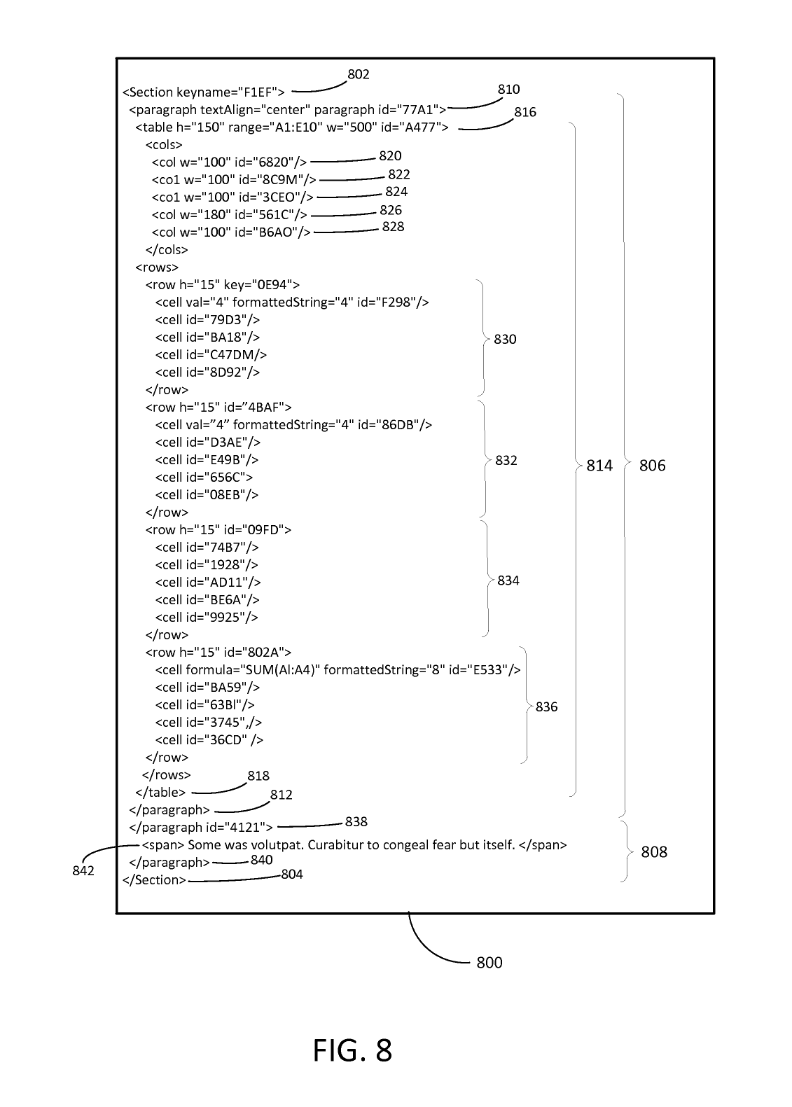

In an embodiment, the mark-up language block of a section entity (e.g., the mark-up language block 458 of the section entity 412) includes one or more elements made up of various tags, attributes, and content that are usable by the productivity server 100 and (in some embodiments) one or more of the computing devices 104, 106, and 108 to render the section on a display. Turning to FIG. 8, an example of a possible implementation of the mark-up language block of the first section entity 534 associated with the third document revision entity 508 is shown. The mark-up language block 800 is bounded by a first tag 802 and a second tag 804. The first tag 802 includes the key name of the first section entity 534. The mark-up language block 800 also includes a first paragraph element 806 and a second paragraph element 808. The first paragraph element 806 is bounded by a first tag 810 and a second tag 812. The first tag 810 of the first paragraph element 806 includes various paragraph formatting attributes and a paragraph id. Within the first paragraph element 806 is a table element 814 bounded by a first tag 816 and a second tag 818. The first tag 816 of the table element 814 includes various formatting attributes and a table id. The table element 814 includes a first column element 820, a second column element 822, a third column element 824, a fourth column element 826, and a fifth column element 828. The table element 814 further includes a first row element 830, a second row element 832, a third row element 834, and a fourth row element 836. Each row element is bounded by a pair of tags in which the first tag of the pair includes a row id. Furthermore, each row element includes a cell element for each column (five in the example of FIG. 8). Each cell element likewise includes a cell id. The second paragraph element 808 is bounded by a first tag 838 and a second tag 840. The first tag 838 includes a paragraph id. The second paragraph element 838 also includes a span element 842, which has a block of text.

According to an embodiment of the disclosure, each time an editor (i.e., a user with editing rights to the document) shares a document with other users (e.g., by prompting the productivity server 100 to unlock the document and propagate the edits to other users having at least read access to the document), the productivity server 100 creates a new revision.

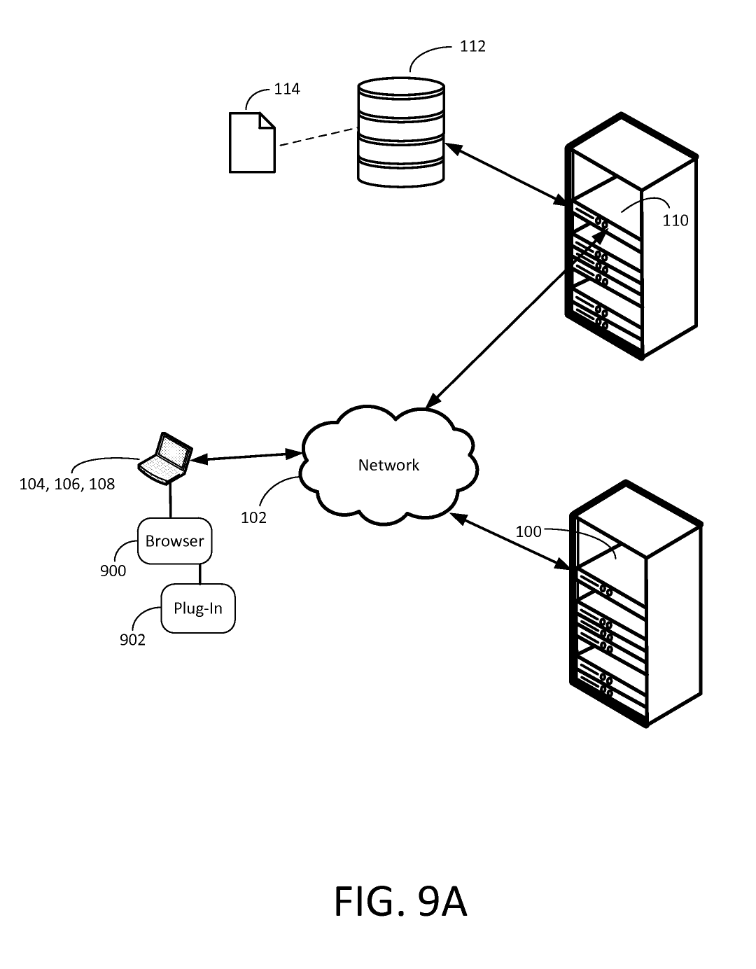

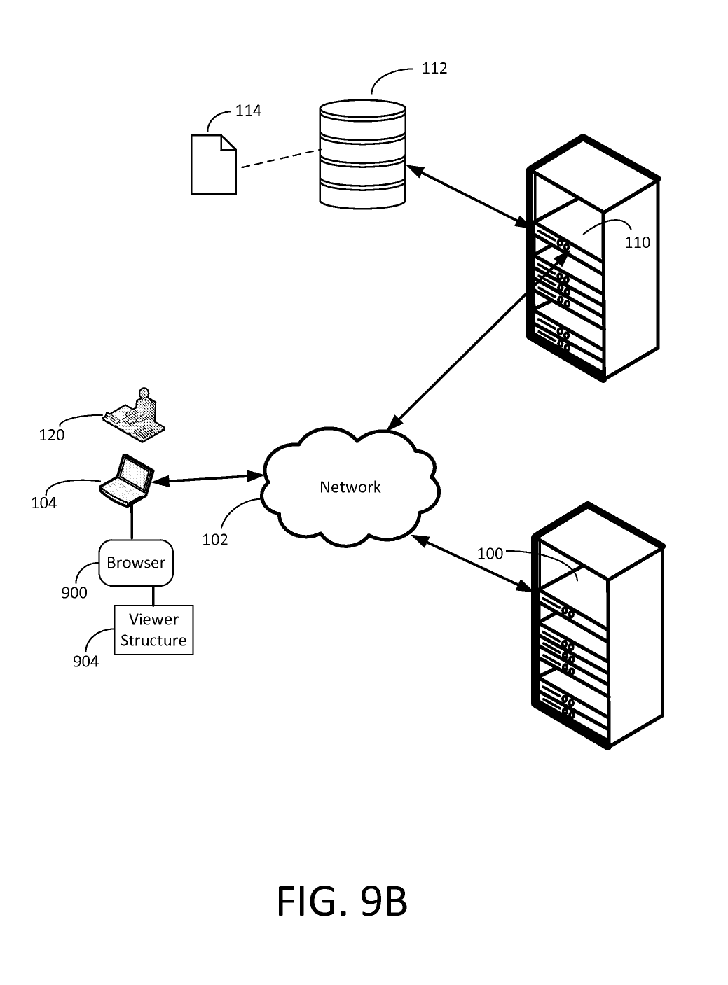

Turning to FIG. 9A, in an embodiment, one or more of the second, third, and fourth computing devices 104, 106, and 108 executes a web browser program 900 (“browser 900”). The browser 900 executes a plug-in program 902 (e.g., an Adobe Flash® plug-in). The plug-in program 902 (“plug-in 902”) and the productivity server 100 communicate with one another using, for example, a scripting language such as JavaScript® or ActionScript® in combination with hypertext transport protocol (“HTTP”) requests and responses (e.g., GET and POST). The plug-in 902 receives an input from a user (e.g., as a mouse click on an icon representing a document). In response to the input, the computing device, under the control of the plug-in 902, transmits a request for the document to the productivity server 100. The productivity server 100 then transmits a corresponding request (e.g., an HTTP “GET” request or a structured database query) that includes the key name of the document (i.e., the key name of the document parent entity) to the database server 110. The database server 110 retrieves the entities that constitute the document from the media storage device 112 and transmits the entities to the productivity server 100. The productivity server 100 transmits the relevant mark-up language blocks to the computing device (e.g., the mark-up language blocks of a section entity, a tree entity, and a section map entity), which, under the control of the plug-in 902, interprets the mark-up language blocks and renders the mark-up language blocks on the display 210 which, in effect, renders the document (e.g., a particular section of the document) on the display 210.

To illustrate, assume that the first user 122 interacts with the user interface 300 (which is being displayed by the plug-in 902 on the second computing device 104) to request the first section of the first document 114. The first user 122 does this by left-clicking on the “Section 1” friendly name in the outline 306. In response to the user input, the plug-in 902 uses the mark-up language block 700 of the tree entity 522 to determine the section id of “Section 1,” which is 0001. The plug-in 902 uses the mark-up language block of the section map entity 524 (assumed to be the mark-up language block 600 in this example) to map the section id 0001 to the key name of the appropriate section entity. As shown in FIG. 6, section id 0001 maps to the key name F1EF. The plug-in 902 operates in conjunction with the browser 900 to transmit a request to the productivity server 100 for the first section of the first document 114. The request includes the key name F1EF, which the productivity server 100 uses to retrieve the first section entity 534 from the database server 110. The productivity server 100 transmits the mark-up language block (assume to be the mark-up language block 800 in this example) to the second computing device 104. The plug-in 902 renders the mark-up language block 800 on the display of the second computing device 104, resulting in the view shown in FIG. 3 on the user interface 300.

Turning to FIG. 9B, in another embodiment, the one or more of the computing devices 104, 106, and 108 communicates with the productivity server 100 through the browser 900 without the use of a plug-in program. In this embodiment, the browser 900 and the productivity server 100 communicate with one another using, for example, a scripting language such as JavaScript® in combination with HTTP requests and responses. For example, assume that the browser 900 receives an input from the first user 120, such as a mouse click on an icon representing the document 114. In response to the input, the second computing device 104, under the control of the browser 900, transmits a request for the first document 114 to the productivity server 100. The productivity server 100 then retrieves the multiple data items that constitute the first document 114 (e.g., as described above in conjunction with FIG. 5) using direct references (e.g., calling up the entity by its key name from the database server 110) or indirect references (e.g., querying the database server 110 for all entities that have the key name of the document as a property). Entities that the productivity server 100 may retrieve include the various mark-up language blocks. The productivity server 100 then translates the mark-up language blocks into drawing commands (e.g., scalable vector graphics commands invoked by JavaScript®) and transmits those drawing commands to the browser 900. The browser 900 renders the document 114 on the display 210 according to the drawing commands. Additionally, the productivity server 100 provides, to the browser 900, a viewer structure 904. The viewer structure 904 is a data structure that maps coordinates on the user interface 300 (e.g., XY coordinates on the display 210) to the parts of the outline in the outline area 302 or identifiers (i.e., asset ids, such as table ids, paragraph ids, page ids, etc.) of user content in the user content area 302.

To illustrate, assume that the first user 120 interacts with the user interface 300 (which is being displayed by the browser 300 on the second computing device 104) to request the first section of the first document 114. The first user 120 does this by left-clicking on the “Section 1” friendly name in the outline 306. In response to the user input, the browser 900 detects the coordinates of the location of the click and uses the viewer structure 904 to determine the asset to be requested. In this example, the browser 900 determines that the asset with the section id 0001 should be requested. The browser 900 then uses the viewer structure 904 to map the section id 0001 to the key name of the appropriate section entity (F1EF in this example). The browser 900 transmits a request to the productivity server 100 for the asset whose key name is F1FE. The request includes the key name F1EF, which the productivity server 100 uses to retrieve the first section entity 534 from the database server 110. The productivity server 100 translates the mark-up language block (assume to be the mark-up language block 800 in this example) into drawing commands and transmits the drawing commands to the browser 900. The browser 900 renders the drawing commands on the display of the second computing device 104, resulting in the view shown in FIG. 3A, FIG. 3B, and FIG. 3C on the user interface 300.

For example, assume that the second computing device 104 uses the architecture shown in FIG. 9A. Further assume that (via the user interface 300) the first user 120 selects the word “itself” on the user interface 300 (e.g., via one of the user input devices 208 of the second computing device 104), right-clicks, and selects “Add Comment” from a pop-up menu. The plug-in 902 detects the location on the user interface 300 (e.g., in terms of XY coordinates) and, using the mark-up language block 800, identifies which asset of the document 114 is closest to the location. In this example, the selected text “itself” is closest to the second paragraph, whose paragraph id is 4121 (as seen in the tag 838). The plug-in 902 also determines a character offset of the start of the selection and a character offset of the end of the selection. The plug-in 902 determines these offsets relative to the start of the paragraph. Thus, in this example, the start offset value is 50 and the end offset value is 56 (i.e., the number of characters, including spaces, from the start of the paragraph to the beginning of the selected text and to the end of the selected text). The plug-in 902 displays a comment box on the user interface 300 to allow the first user 120 to enter a comment. The first user 120 types in the comment which, in this example, is “I don't know about the last term,” into the first comment box 332. The plug-in 902, in conjunction with the browser 900, transmits the following to the productivity server 100: the key name of the first section entity 534, the paragraph id of the second paragraph element 808, the offset value of the start of the selection and the offset value of the end of the selection along with a request to create a comment thread.

In another embodiment, assume that the second computing device 104 uses the architecture of FIG. 9B. Further assume that the first user 120 taps within the area of the display of the user interface 350 that contains the paragraph 358. The browser 900 detects the location on the user interface 350 (e.g., in terms of XY coordinates) and, using the viewer structure 904 (which, as noted above, maps the user interface or screen coordinates to asset identifiers), identifies which asset of the document 114 contains the location. In the viewer structure 904, the XY coordinate maps to the paragraph id of the paragraph 358. The browser 900 displays a first comment box 384 (FIG. 3D) on the user interface 350 to allow the first user 120 to enter a comment. Turning to FIG. 3E, the first user 120 types in the comment which, in this example, is “I don't know about this last term,” into the first comment box 384. The browser 900 transmits the following to the productivity server 100: the key name of the section entity currently being displayed and the paragraph id of the paragraph 358 (with which the comment is to be associated).

In response to the request from the computing device, the productivity server 100 instantiates (i.e., creates an instance of) the comment thread entity 538 and the first comment entity 540, each of which has a key name randomly generated by the database server 110 (1E7B and 1213 respectively in the example of FIG. 5). The productivity server 100 stores (via the database server 110) the key name of the first comment entity 540 within the comment thread entity 538. The productivity server 100 also stores the text of the first user's comment within the first comment entity 540. In some embodiments, the productivity server stores a set of metadata representing the position for each comment thread in the section support data entity. Those positions get updated in response to changes to the document section.

The productivity server 100 is able to retrieve the comment thread entity 538 from the database server 110 by query, if need be. For example, if a user logs into the productivity server 100 and (via the user's computing device) requests a document (or section thereof), the productivity server submits a query to the database server 110 to retrieve all comment thread entities that contain (e.g., have, as one of its properties) the document id of the requested document and that contain (e.g., have, as one of its properties) the section id of the requested section.

Continuing the example, the respective browsers on the third computing device 106 and the fourth computing device 108 each make periodic requests to the productivity server 108 for any updates to the section being displayed. Once the productivity server 100 finishes instantiating and storing the first comment, the productivity server 100 transmits information regarding the first comment to both the third computing device 106 and the fourth computing device 108. Each of the third and fourth computing devices displays an icon 368 representing the first user's comment on the user interface 350. The second user 122 chooses to reply to the comment and interacts with the user interface 350 by tapping the icon 386 on a touchscreen display. The user interface 350 then displays the second comment box 386 (FIG. 3G). The second user 122 types the second comment (shown as “Business? What's wrong with that?”) into the second comment box 386 and taps the “Reply” button on the user interface 300. Assuming that the third computing device 106 is using the architecture of FIG. 9B, the browser 900 transmits a request to the productivity server 100 to add the comment to the comment thread 332. The request includes the text of the comment and the key name of the comment thread entity 538 (1E7B). In response, the productivity server 100 instantiates the second comment entity 542, which has a key name randomly generated by the database server 110 (BE37 in this example).

The fourth user 124 chooses to reply to the comment and interacts with the user interface 350 to indicate this. The user interface 350 then displays the third comment box 388 (FIG. 3C). The fourth user 124 types the third comment (shown as “I think it's fine.”) into the third comment box 338 and taps the “Reply” button on the user interface 350. Assuming the architecture of FIG. 9B, the browser 900 transmits a request to the productivity server 100 to add the comment to the comment thread 332. The request includes the text of the comment and the key name of the comment thread entity 538 (1E7B in this example). In response, the productivity server 100 instantiates the third comment entity 544, which has a key name randomly generated by the database server 110 (AD52 in this example).

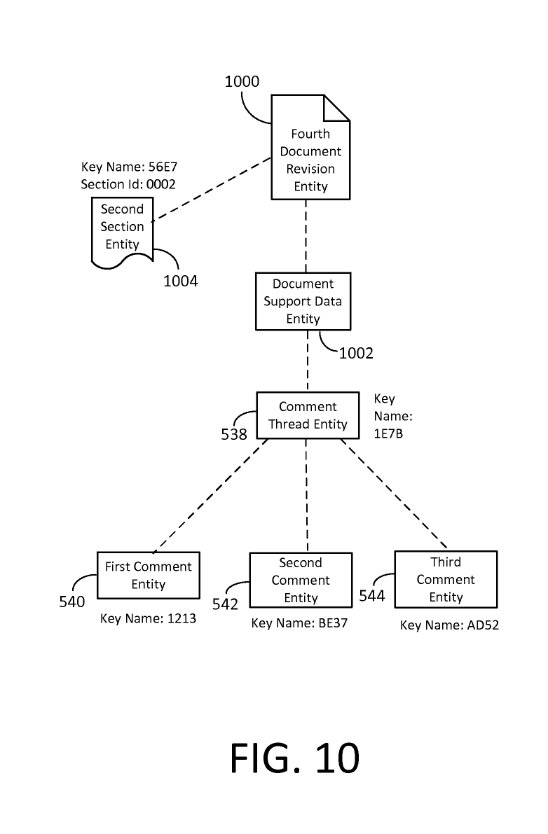

In an embodiment, the comment thread 334 generated by the users of FIG. 1 follows the content to which it is associated (or anchored) even if a user moves the content. For example, assume that a user with editing rights to the first document 114 moves the second paragraph 330 from the first section to the second section (e.g., interacts with the user interface to cause the browser or plug-in to, in effect, send a request to the productivity server 100 to have the paragraph moved). Once the user shares the change, the productivity server 100 reacts by creating (e.g., requests that the database server 110 create) a fourth document revision entity 1000 (shown in FIG. 10), a new instance 1002 of the first section entity, and the other entities previously discussed, including a new document support data entity 1004. The productivity server 100 puts a reference to the comment thread entity 538 (e.g., the key name, which is 1E7B in this example) in the document support data entity 1004. Therefore, when a computing device (e.g., the second computing device 122) requests the second section, the productivity server 100, in carrying out the process described previously for obtaining and delivering the second section to the computing device, is able to provide the comment thread 332 to the computing device without the need for having to make any actual change to the comment thread 332 itself.

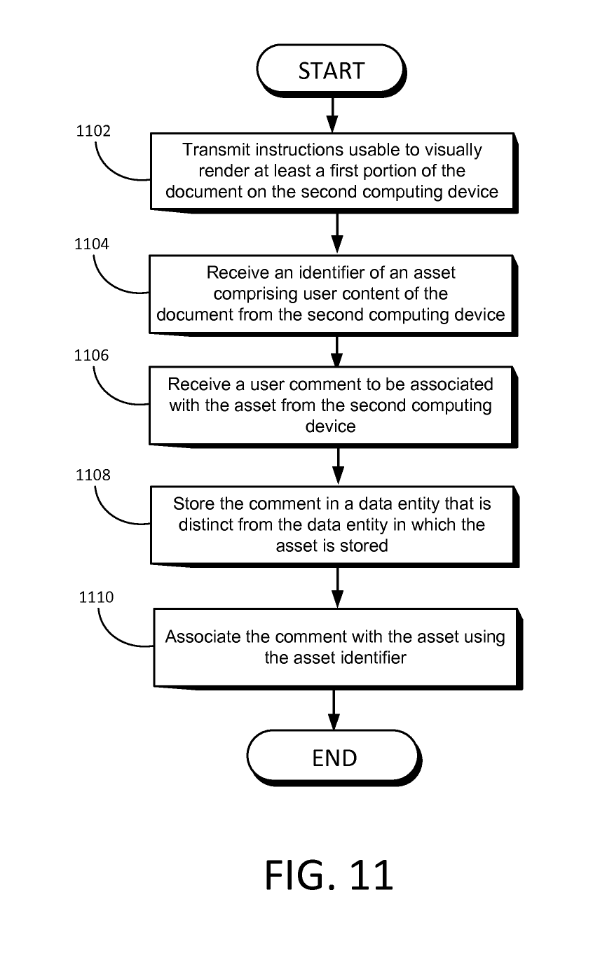

Turning to FIG. 11, a procedure carried out by the productivity server 100 (e.g., by the processor 102) to process comments on a document in an embodiment is described. At block 1102, the productivity server 100 transmits instructions usable to visually render at least a portion of the document on the second computing device 104. The instructions may take the form of, for example, a block of mark-up language instructions or drawing instructions. At block 1104, the productivity server 100 receives an identifier of an asset having user content of the document from the second computing device 104. At block 1106, the productivity server 100 receives a user comment to be associated with the asset from the second computing device. At block 1108, the productivity server 100 stores the comment in a data entity that is distinct from the data entity in which the asset is stored (e.g., in the media storage device 112 via the database server 110). At block 1110, the productivity server 100 associates the comment with the asset using the asset identifier.

It should be understood that the exemplary embodiments described herein should be considered in a descriptive sense only and not for purposes of limitation. Descriptions of features or aspects within each embodiment should typically be considered as available for other similar features or aspects in other embodiments. It will be understood by those of ordinary skill in the art that various changes in form and details may be made therein without departing from their spirit and scope of as defined by the following claims. For example, the steps of the flowchart of FIG. 11 can be reordered in ways that will be apparent to those of skill in the art.

What is claimed is:

1. On a first computing device, a method for processing comments on a document, the method comprising:
transmitting, to a second computing device, instructions usable to visually render at least a first portion of the document on the second computing device;
receiving, from the second computing device,
an identifier of an asset of the document, wherein the asset comprises user content of the document, and
a user comment to be associated with the asset;
storing the comment in a data entity that is distinct from a data entity in which the asset is stored; and
associating the comment with the asset using the asset identifier.

2. The method of claim 1, wherein
transmitting instructions to the second computing device comprises transmitting a mark-up language block to the second computing device, and
the mark-up language block includes the user content of the first portion of the document.

3. The method of claim 1, further comprising translating a mark-up language block containing the user content into drawing instructions,
wherein transmitting instructions to the second computing device comprises transmitting the drawing instructions to the second computing device.

4. The method of claim 1, further comprising:
receiving a request to move the asset from the first portion of the document to a second portion of the document;
transmitting, to the second computing device,
instructions usable by the second device to visually render the second portion on the second device, and
data that associates the comment with the asset identifier.

5. The method of claim 1, further comprising:
receiving, from the second computing device, an identifier of a first user who authored the comment;
instantiating a comment thread entity;
associating the comment thread entity with the asset identifier;
receiving, from a third computing device,
a second comment subsequent to the comment from the second computing device, and
an identifier of a second user who authored the second comment;
associating the second comment with the comment thread entity; and
storing the second comment in a data entity that is distinct from the data entity in which the asset is stored.

6. The method of claim 1, further comprising:
receiving a request for a section from the first computing device, wherein the request includes a key name of the section;
querying a database for all comment thread entities that include the key name;
in response to the query, receiving a plurality of comment thread entities; and
translating a mark-up language block containing the user content into drawing instructions,
wherein transmitting instructions to the second computing device comprises transmitting the drawing instructions to the second computing device.

7. On a computing device comprising a display, a method for processing comments on a document, the method comprising:
receiving a mark-up language block from a server, wherein the mark-up language block includes user content of the document;
using the mark-up language block to render the document in a non-editable form on the display;
receiving, via a user interface, a user selection of a location on the display;
referencing the mark-up language block to identify the underlying asset of the document corresponding to the selected location;
receiving, via the user interface, a comment associated with the identified underlying asset;
transmitting, to the server,
an identifier of the underlying asset, and
the received comment; and
visually rendering the entered comment on the display device.

8. The method of claim 7,
wherein referencing the mark-up language block to identify the underlying asset comprises detecting the coordinates of the location and using the mark-up language to identify which asset of the document is closest to the location.

9. The method of claim 8, further comprising:
determining an absolute coordinate of the start of the identified asset that is to serve as an anchor for the received comment;
determining an offset from the absolute coordinate;
transmitting, to the server, the absolute coordinate and the offset,
wherein visually rendering the entered comment comprises visually rendering the comment in association with the identified asset.

10. The method of claim 8, further comprising:
determining a reference point;
determining a distance offset from the reference point;
transmitting, to the server, the reference point and the distance offset,
wherein visually rendering the entered comment comprises visually rendering the comment in association with the identified asset that is to serve as an anchor for the comment.

11. The method of claim 8, further comprising:
determining a reference point;
determining a relative offset from the reference point;
transmitting, to the server, the reference point and the relative offset,
wherein visually rendering the entered comment comprises visually rendering the comment in association with the identified asset that is to serve as an anchor for the comment.

12. The method of claim 8, wherein transmitting an identifier of the underlying asset comprises transmitting:
a key name of a section entity in which the mark-up language block is stored; and
a paragraph identifier of the paragraph corresponding to the location.

13. A computing device communicatively linked to a network, the computing device comprising a processor that executes instructions for carrying out a method comprising
transmitting, to a second computing device, instructions usable to visually render at least a first portion of a document on the second computing device;
receiving, from the second computing device,
an identifier of an asset of the document, wherein the asset comprises user content of the document, and
a user comment to be associated with the asset;
storing the comment in a data entity that is distinct from the data entity in which the asset is stored; and
associating the comment with the asset using the asset identifier.

14. The computing device of claim 13, wherein
transmitting instructions to the second computing device comprises transmitting a mark-up language block to the second computing device, and
the mark-up language block includes the user content of the first portion of the document.

15. The computing device of claim 13, wherein receiving the identifier of the asset of the document comprises receiving the paragraph identifier corresponding to a paragraph with which the comment is to be associated, the method further comprising:
storing the comment in a database in a comment entity; and
storing the paragraph identifier in the database within the comment entity.

16. The computing device of claim 13, wherein receiving the identifier of the asset of the document comprises receiving the paragraph identifier corresponding to a paragraph with which the comment is to be associated.

17. The computing device of claim 13, wherein
the method further comprises translating a mark-up language block containing the user content into drawing instructions,
transmitting instructions to the second computing device comprises transmitting the drawing instructions to the second computing device.

18. The computing device of claim 13, wherein the method further comprises:
receiving a request to move the asset from the first portion of the document to a second portion of the document;
transmitting, to the second computing device,
instructions usable by the second device to visually render the second portion on the second device, and
data that associates the comment with the asset identifier.

19. The computing device of claim 13, wherein the method further comprises:
receiving, from the second computing device, an identifier of a first user who authored the comment;
instantiating a comment thread entity;
associating the comment thread entity with the asset identifier;
receiving, from a third computing device,
a second comment subsequent to the comment from the second computing device, and
an identifier of a second user who authored the second comment;
associating the second comment with the comment thread entity; and
storing the second comment in a data entity that is distinct from the data entity in which the asset is stored.

20. The computing device of claim 13, wherein the method further comprises:
receiving a request for a section from the first computing device, wherein the request includes an key name of the section;
querying a database for all comment thread entities that include the key name;
in response to the query, receiving a plurality of comment thread entities; and
translating a mark-up language block containing the user content into drawing instructions,
wherein transmitting instructions to the second computing device comprises transmitting the drawing instructions to the second computing device.
